(19) United States
(12) Patent Application Publication
(10) Pub. No.: US 2026/0089273 A1
(43) Pub. Date: Mar. 26, 2026

(54) IMAGE FORMING APPARATUS

(71) Applicant: Toshiba Tec Kabushiki Kaisha, Tokyo (JP)

(72) Inventor: Yoshiki KOGISO, Numazu Shizuoka (JP)

(21) Appl. No.: 19/290,870

(22) Filed: Aug. 5, 2025

(30) Foreign Application Priority Data
Sep. 25, 2024 (JP) 2024-166643

(51) Int. Cl. H04N 1/00; G03G 15/00; G03G 15/01; G03G 15/22; G03G 21/16; G06K 7/10; H04N 1/32

(52) U.S. Cl. CPC H04N 1/00342; G03G 15/0189; G03G 15/22; G03G 15/5016; G03G 15/6564; G03G 15/6567; G03G 15/6588; G03G 21/1657; G06K 7/10366; H04N 1/32138

(57) ABSTRACT

In accordance with an embodiment, an image forming apparatus performs, in a case where recognition processing for a target wireless tag has failed, at least one of stepwisely decreasing a reception threshold of radio signal strength to be returned from the target wireless tag or stepwisely increasing radio signal strength to be transmitted to the target wireless tag and reads data prestored by the wireless tag communication apparatus. The image forming apparatus performs re-recognition processing for recognizing the target wireless tag on the basis of the read data. The image forming apparatus notifies a user that the medium having the target wireless tag recognized in the re-recognition processing is a re-recognized medium whose target wireless tag has been recognized in the re-recognition processing.

### CROSS-REFERENCE TO RELATED APPLICATIONS

This application is based upon and claims the benefit of priority from the prior Japanese Patent Application No. 2024-166643, filed on Sep. 25, 2024, the entire contents of which are incorporated herein by reference.

### FIELD

An embodiment described here generally relates to an image forming apparatus.

### BACKGROUND

An image forming apparatus with an RFID reader/writer function that is capable of not only forming an image on an RFID-tagged medium, which s paper embedded with a radio frequency identifier (RFID) tag, a kind of wireless tag, but also writing data to the RFID tag is known.

The RFID tag has a user area, in which a user writes desired arbitrary data, and an electronic product code (EPC) area. In general, identification data for determining a purpose of the RFID tag, i.e., indicating what data written in the user area represents is written in the EPC area. The identification data includes, for example, initial data indicating the RFID tag manufacturer, chip type, etc. It should be noted that, depending on the user's RFID use, the user may write arbitrary user data in the EPC area. Although a general use will be described hereinafter, it does not necessarily mean that both identification data and user data are written.

When forming an image on an RFID-tagged medium, the image forming apparatus first writes identification data and user data to the RFID tag, and then forms an image on the medium on which the data has been written.

In such an image forming apparatus, the conventional proposal is to improve the success rate of reading and writing to the RFID tag by, for example, increasing the radio signal strength to be transmitted to the RFID tag and performing a read operation when the data writing to the RFID tag fails.

In the conventional image forming apparatus, in a case where data writing fails even when the radio signal strength is increased to the maximum value, the RFID tag is determined to malfunction. A paper with an embedded RFID tag that is determined to malfunction is output from the image forming apparatus as blank paper without image formation and discarded.

However, the cause of data writing failure may not be the malfunction of the RFID tag, but a case where radio signal strength (received signal strength indicator (RSSI)) returned from the tag is weaker than that of a normal tag due to variations caused by individual differences in the tag. Even in the latter case, the tag is conventionally discarded like a malfunctioning tag. In this manner, there is conventionally a problem in that the apparatus side determines to waste the high unit price RFID-tagged media by assuming that the RFID tags malfunction.

### BRIEF DESCRIPTION OF THE DRAWINGS

FIG. 1 is a schematic cross-sectional view showing an example of an image forming apparatus according to an embodiment.

FIG. 2 is a perspective view showing an example of an output part of the image forming apparatus according to the embodiment.

FIG. 3 is a block diagram showing an example of a circuit configuration of a controller of the image forming apparatus according to the embodiment.

FIG. 4 is a block diagram showing an example of a configuration of a processor in FIG. 3.

FIG. 5 is a diagram showing a first portion of a series of flowcharts showing an example of the RFID processing by the image forming apparatus according to the embodiment.

FIG. 6 is a diagram showing a second portion of the series of flowcharts showing the example of the RFID processing by the image forming apparatus according to the embodiment.

FIG. 7 is a diagram showing a third portion of the series of flowcharts showing the example of the RFID processing by the image forming apparatus according to the embodiment.

FIG. 8 is a diagram showing a fourth portion of the series of flowcharts showing the example of the RFID processing by the image forming apparatus according to the embodiment.

FIG. 9 is a diagram showing a fifth portion of the series of flowcharts showing the example of the RFID processing by the image forming apparatus according to the embodiment.

### DETAILED DESCRIPTION

In accordance with an embodiment, an image forming apparatus includes an image forming device, a wireless tag communication device, and a processor. The image forming device forms an arbitrary image on a medium having a target wireless tag, which is a wireless tag that is a data writing target. The wireless tag communication device is arranged at a predetermined position with respect to the image forming device and communicates with the target wireless tag of the medium, and writes data to the target wireless tag and reads data written to the target wireless tag. Preceding writing of arbitrary data to the target wireless tag by the wireless tag communication device, the processor reads data prestored in the target wireless tag by the wireless tag communication device and performs recognition processing for recognizing the target wireless tag on the basis of the read data. In a case where the recognition processing for the target wireless tag has failed, the processor performs at least one of stepwisely decreasing a reception threshold of radio signal strength to be returned from the target wireless tag or stepwisely increasing radio signal strength to be transmitted to the target wireless tag, reads data prestored by the wireless tag communication device, and performs re-recognition processing for recognizing the target wireless tag on the basis of the read data. In addition, the processor notifies a user that the medium having the target wireless tag recognized in the re-recognition processing is a re-recognized medium whose target wireless tag has been recognized in the re-recognition processing.

Hereinafter, an image forming apparatus according to an embodiment will be described with reference to the drawings. It should be noted that in each drawing used for describing the following embodiment, scales of respective parts may be changed as appropriate. In the drawings, the same reference signs denote the same or similar portions. Moreover, in each drawing used for describing the following embodiment, configuration(s) may be omitted for the sake of description.

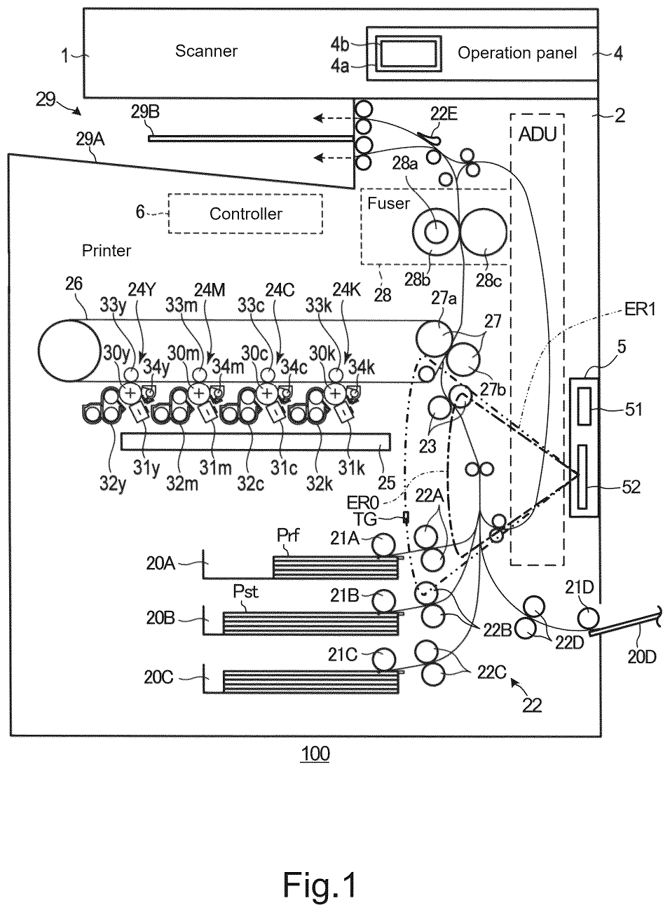

FIG. 1 is a schematic cross-sectional view showing an example of an image forming apparatus 100 according to the embodiment. The image forming apparatus 100 is a digital multifunction peripheral (multi-functional peripheral (MFP)) that is installed in a work place, such as an office. The image forming apparatus 100 includes a scanner 1, a printer 2, an operation panel 4, an RFID reader/writer 5, and a controller 6.

The scanner 1 is an apparatus that reads an image of an original document and converts the image into image data. For example, the scanner 1 is constituted by a charge coupled device (CCD) line sensor that converts an image on a reading surface of the original document into image data. The scanner 1 may have a function to scan the original document placed on an original document support glass. Moreover, the scanner 1 may have a function of reading the image of the original document conveyed by an auto document feeder (ADF). For example, the scanner 1 is mounted on an upper portion of the main body of the MFP. The controller 6 controls the scanner 1. The scanner 1 outputs the image data of the original document to the controller 6.

The printer 2 is an electrophotographic printer. The printer 2 forms an image on paper that is a recording medium. The printer 2 has a color printing function that prints color images on paper and a monochrome (e.g., black) printing function that prints monochrome (e.g., black) images on paper. The printer 2 forms color images using toner in multiple colors (e.g., three colors such as yellow (Y), cyan (C), and magenta (M)). Moreover, the printer 2 forms monochrome images using monochrome (e.g., black (K)) toner in monochrome.

In the configuration example shown in FIG. 1, the printer 2 includes paper feed cassettes 20A, 20B, and 20C. The paper feed cassettes 20A, 20B, and 20C are paper feed parts that feed paper on which an image is to be printed. The paper feed cassettes 20A, 20B, and 20C each hold paper of a set type (e.g., size, paper quality). The printer 2 further includes a manual feed tray 20D as a paper feed part. The manual feed tray 20D holds paper of any type (e.g., size, paper quality). The paper set to the paper feed cassettes 20A, 20B, and 20C and the manual feed tray 20D can be regular paper Pst or RFID tagged paper (hereinafter, referred to as RFID paper) Prf that is a medium embedded with an RFID tag. That paper is cut to any size. In the example shown in FIG. 1, the RFID paper Prf is set in the paper feed cassette 20A.

The paper feed cassettes 20A, 20B, and 20C include pick-up rollers 21A, 21B, and 21C, respectively. The pick-up rollers 21A, 21B, and 21C take out sheets of paper one by one from the paper feed cassettes 20A, 20B, and 20C, respectively. Moreover, the manual feed tray 20D also includes a pick-up roller 21D that takes out sheets of paper one by one from the manual feed tray 20D. The pick-up rollers 21A, 21B, 21C, and 21D feed the taken-out sheets of paper to a conveyance path (conveyance device 22). The conveyance path (conveyance device 22) is constituted by a plurality of conveyance rollers 22A, 22B, 22C, and 22D and the like.

The conveyance device 22 conveys paper inside the printer 2. For example, the conveyance device 22 conveys paper taken out by the pick-up rollers 21A, 21B, 21C, and 21D to resist rollers 23. The resist rollers 23 stop the conveyance of the paper, thereby correcting the inclination of the paper to be perpendicular to a conveyance direction. The resist rollers 23 convey the paper to a transfer position at a timing when the resist rollers 23 transfer an image to the paper from a transfer belt 26. The conveyance device 22 conveys the paper passing through the resist rollers 23 to the transfer position. The conveyance device 22 conveys the paper passing through the transfer position to a fuser 28 from the transfer position. The conveyance device 22 conveys the paper passing through the fuser 28 to an output part 29 or automatic double-sided unit (ADU). Moreover, the conveyance device 22 includes a flapper 22E in front of the output part 29. The flapper 22E switches an output destination of the paper between a first output part and a second output part of the output part 29 in accordance with a control signal from the controller 6.

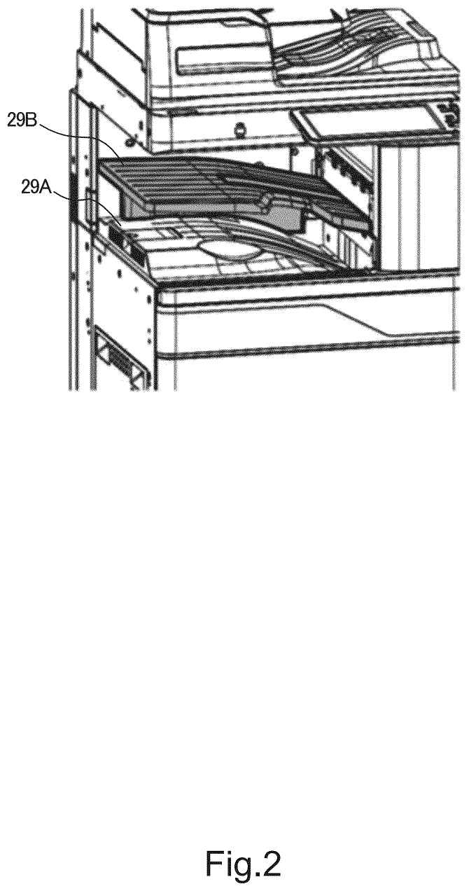

FIG. 2 is a perspective view showing an example of the output part 29 of the image forming apparatus. As shown in FIG. 2, the output part 29 includes a lower output tray 29A that functions as the first output part and an upper output tray 29B that functions as the second output part.

The printer 2 includes a plurality of image forming units 24Y, 24M, 24C, and 24K. The plurality of image forming units 24Y, 24M, 24C, and 24K forms an image that is transferred to the paper. In the configuration example shown in FIG. 1, the image forming unit 24Y forms an image with yellow toner. The image forming unit 24M forms an image with magenta toner. The image forming unit 24C forms an image with cyan toner. The image forming unit 24K forms an image with black toner.

Image forming units 24Y, 24M, 24C, and 24K include photosensitive drums 30y, 30m, 30c, and 30k, chargers 31y, 31m, 31c, and 31k, developers 32y, 32m, 32c, and 32k, transfer rollers 33y, 33m, 33c, and 33k, and cleaners 34y, 34m, 34c, and 34k. Differences in configuration of the image forming units 24Y to 24K, the photosensitive drums 30y to 30k, chargers 31y to 31k, developers 32y to 32k, transfer rollers 33y to 33k, and cleaners 34y to 34k are only the colors. Thus, hereinafter, the image forming units 24Y to 24K may be simply referred to as image forming units 24, excluding a case where it is especially necessary to distinguish them. The photosensitive drums 30y to 30k may also be simply referred to as photosensitive drums 30. The chargers 31y to 31k may also be simply referred to as chargers 31. The developers 32y to 32k may also be simply referred to as developers 32. The transfer rollers 33y to 33k may also be simply referred to as transfer rollers 33. The cleaners 34y to 34k may also be simply referred to as cleaners 34.

The photosensitive drum 30 is an image carrier on which an electrostatic latent image is formed. The photosensitive drum 30 is rotated by a rotation shaft. The charger 31 charges the surface of the photosensitive drum 30 to a predetermined potential. The charger 31 has a grid (not shown) for adjusting the charging output to the photosensitive drum 30. The developer 32 develops the electrostatic latent image formed on the photosensitive drum 30 with toner. The transfer roller 33 transfers the toner image developed on the photosensitive drum 30 to the transfer belt 26. The cleaner 34 cleans the surface of the photosensitive drum 30 after transfer.

An exposure device 25 forms the electrostatic latent image on the photosensitive drum 30 of each of the image forming units 24Y, 24M, 24C, and 24K by laser light. The exposure device 25 irradiates the photosensitive drum 30 with laser light controlled in accordance with the image data via an optical system, such as a polygon mirror. The laser light from the exposure device 25 forms the electrostatic latent image on the surface of each photosensitive drum 30. The exposure device 25 controls laser light in accordance with a control signal from the controller 6.

The image forming unit 24 develops the electrostatic latent image formed on the photosensitive drum 30 by the developer 32. The developer 32 includes a developing container having a developing roller. The developing container contains toner as a developer of the color of the image forming unit 24. The toner is charged by being agitated in the developing container together with the carrier. A developing bias is applied on the developing roller. The developing roller on which the developing bias is applied supplies toner to the electrostatic latent image on the photosensitive drum 30. The electrostatic latent image on the photosensitive drum 30 is developed as a toner image with the supplied toner.

The transfer belt 26 is an intermediate transfer body. The image forming unit 24 transfers (primarily transfers) the toner image formed on the photosensitive drum 30 to the transfer belt 26 by applying a primary transfer voltage on the transfer belt 26 through the transfer roller 33. For example, the image forming unit 24K transfers the toner image developed by the developer 32k with black toner onto the transfer belt 26 through the transfer roller 33k. Moreover, in a case of forming a color image, each of the image forming units 24Y, 24M, 24C, and 24K transfers a toner image developed with toner of each color overlaid on the transfer belt 26.

A transfer unit 27 transfers the toner image on the transfer belt 26 to the paper at a secondary transfer position. In other words, the transfer unit 27 prints an image on the paper. The transfer unit 27 can be called a printing part. The secondary transfer position that is a printing position is a position where the toner image on the transfer belt 26 is transferred to the paper. The secondary transfer position is a position where a support roller 27a and a secondary transfer roller 27b face each other.

The fuser 28 fuses the toner to the paper. The fuser 28 provides heat to the paper for fusing. In the example shown in FIG. 2, the fuser 28 is constituted by a heat roller 28b having a built-in heating part 28a and a pressure roller 28c that comes into contact with a fuser belt heated by the heat roller 28b under pressure. The heating part 28a only needs to be a temperature-controllable heater. For example, the heating part 28a may be constituted by a heater lamp, such as a halogen lamp, or may be an induction heating (IH) heater. Moreover, the heating part 28a may be constituted by a plurality of heaters. The fuser 28 conveys the fixed paper to the output part 29 or ADU.

The operation panel 4 is a user interface. The operation panel 4 includes a display device 4a and a touch panel 4b including various buttons. The controller 6 controls contents to be displayed on the display device 4a of the operation panel 4. The display device 4a functions as a notification unit. Moreover, the operation panel 4 outputs information, which are input to the touch panel 4b or buttons of the operation panel 4, to the controller 6. The user specifies an operation mode on the operation panel 4 and inputs information such as setting information.

The RFID reader/writer 5 is an example of a wireless tag communication apparatus including a controller, which is called an RFID module 51, and an antenna 52. The RFID module 51 writes data input from the controller 6 via the antenna 52 to an RFID tag built in the RFID paper Prf stopped by the resist rollers 23. Moreover, the RFID module 51 reads the data written to the RFID tag via the antenna 52 and outputs to the read-out data to the controller 6. The position, orientation, and directivity of the antenna 52, a reception threshold of radio signal strength (RSSI) to be returned from the RFID tag, and transmission power to the RFID tag, i.e., radio signal strength to be transmitted to the RFID tag, are set so that the RFID reader/writer 5 can read and write from/to the RFID tag of the RFID paper Prf stopped by the resist rollers 23.

The RFID tag built in the RFID paper Prf is a passive type that does not have a battery. The RFID tag operates using received radio waves and transmits the written data. Therefore, when the radio signal strength to be transmitted from an antenna 52 of the RFID reader/writer 5 is weak, the RFID reader/writer 5 can obtain only data from the RFID tag present near the antenna 52. Moreover, also in a case where the reception threshold of the radio signal strength to be returned from the RFID tag, which is received by the antenna 52 of the RFID reader/writer 5, is high, the RFID reader/writer 5 can obtain only data from the RFID tag present near the antenna 52 again. For example, these mean that data cannot be obtained from the RFID tag even when the transmitted radio signal strength is strong in a case where the reception threshold is high, and that data cannot be obtained from the RFID tag if the transmitted radio signal strength is weak even in a case where the reception threshold is low.

The position, orientation, and directivity of the antenna 52 of the RFID reader/writer 5 are set so that as shown by the long dashed short dashed lines in FIG. 1, a standard writable region ER0 that is a prescribed transmission/reception range by the antenna 52 when the RFID reader/writer 5 is at a prescribed reception threshold and prescribed radio signal strength covers the RFID tag of the RFID paper Prf stopped by the resist rollers 23.

By decreasing the reception threshold of the radio signal strength to be returned from the RFID tag, the transmission/reception range of the antenna 52 is extended even if the radio signal strength to be transmitted to the RFID tag is the same. Moreover, even if the reception threshold of the radio signal strength to be returned from the RFID tag is the same, the transmission/reception range of the antenna 52 is extended by increasing radio the signal strength to be transmitted to the RFID tag. However, if the transmission/reception range of the antenna 52 is excessively extended, for example, the RFID tag of the RFID paper Prf set to the paper feed cassette 20A or the manual feed tray 20D or the RFID tag of the RFID paper Prf output to the output part 29 enters the transmission/reception range. Therefore, there is a limit to the transmission/reception range within which the RFID tags of such RFID paper Prf must not enter. In this specification, such a limit of the transmission/reception range is referred to as an access limit region ER1. The access limit region ER1 varies depending on the position, orientation, and directivity of the antenna 52. For example, the access limit region ER1 is a range that does not include the pick-up roller 21A of the nearest paper feed cassette 20A as shown by the long dashed double-short dashed lines in FIG. 1.

In the image forming apparatus 100, a position-fixed tag TG is attached to a fixed position on the boundary position of the access limit region ER1. The position-fixed tag TG is an RFID tag attached to a predetermined fixed position with respect to the antenna 52 of the RFID reader/writer 5. In the EPC area of the position-fixed tag TG, a prescribed value indicating that the tag is the position-fixed tag TG is written as identification data. Therefore, when the RFID reader/writer 5 reads from the RFID tag the prescribed value indicating that the tag is the position-fixed tag TG in decreasing the reception threshold of the radio signal strength to be returned from the RFID tag or increasing the radio signal strength to be transmitted to the RFID tag, it means that the transmission/reception range has been extended to the access limit region ER1. It should be noted that the chip type of the position-fixed tag TG is desirably a tag of the same chip type as the RFID tag of the RFID paper Prf. Therefore, every time the type of RFID paper Prf to be used is changed, the position-fixed tag TG attached to the fixed position is also replaced.

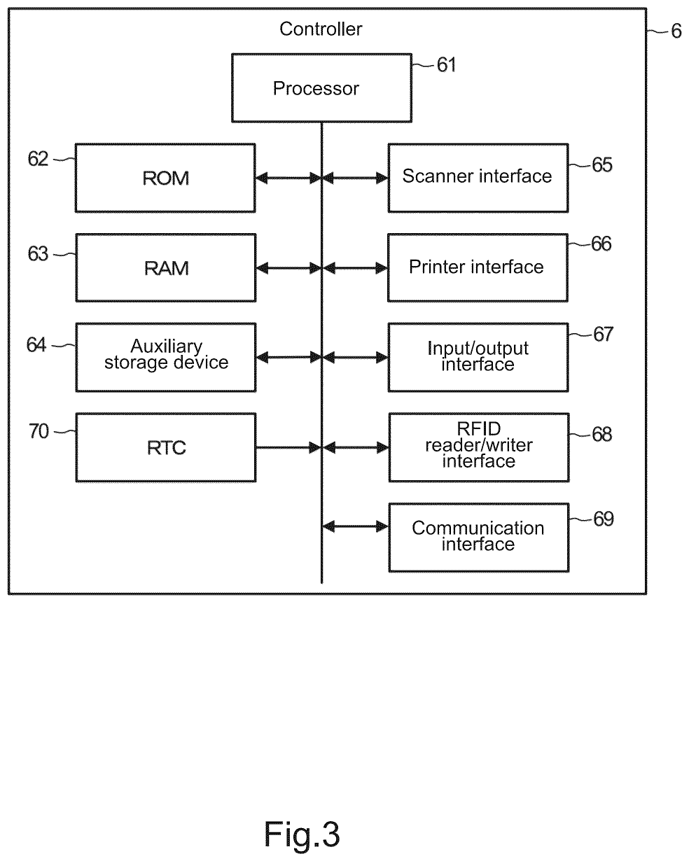

An example of a circuit configuration of the controller 6 of the image forming apparatus 100 will be described with reference to FIG. 3. FIG. 3 is a block diagram showing an example of the circuit configuration of the controller 6. As an example, the controller 6 includes processor 61, a read-only memory (ROM) 62, a random-access memory (RAM) 63, an auxiliary storage device 64, a scanner interface 65, a printer interface 66, an input/output interface 67, an RFID reader/writer interface 68, a communication interface 69, and a real-time clock (RTC) 70.

The processor 61 corresponds to a central part of a computer that performs processing such as arithmetic operations and control necessary for the operation of the image forming apparatus 100. The processor 61 controls the respective parts to realize various functions of the image forming apparatus 100 on the basis of programs such as system software, application software, or firmware stored in the ROM 62, the auxiliary storage device 64, or the like. For example, the processor 61 is a central processing unit (CPU), a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor 61 is a combination of some or all of them.

The ROM 62 is a non-transitory computer-readable storage medium and corresponds to a main storage device of the computer including the processor 61 as a central part. The ROM 62 is a nonvolatile memory used mainly for reading data. The ROM 62 stores data used by the processor 61 in various types of processing, various setting values, or the like.

The RAM 63 corresponds to a main storage device of the computer including the processor 61 as a central part. The RAM 63 is a memory used for reading and writing data. The RAM 63 is used as a so-called work area or the like for the processor 61 to temporarily store data in various types of processing.

The auxiliary storage device 64 is a non-transitory computer-readable storage medium and corresponds to an auxiliary storage device of the computer including the processor 61 as a central part. For example, the auxiliary storage device 64 is an electric erasable programmable read-only memory (EEPROM (registered trademark)), a hard disk drive (HDD), or a solid state drive (SSD). The auxiliary storage device 64 saves data used by the processor 61 in various types of processing, data generated by processing at the processor 61, various setting values, or the like.

It should be noted that in addition to or instead of the auxiliary storage device 64, the image forming apparatus 100 may include an interface that enables insertion of a storage medium, such as a removable optical disc, a memory card, or a universal serial bus (USB) memory.

The program stored in the ROM 62 or the auxiliary storage device 64 includes a program for executing processing to be described later. As an example, the image forming apparatus 100 is transferred to a manager or the like of the image forming apparatus 100 in a state in which the program is stored in the ROM 62 or the auxiliary storage device 64. However, the image forming apparatus 100 may be transferred to the manager or the like in a state in which the program is stored in the ROM 62 or the auxiliary storage device 64. Then, the program for executing the processing to be described later may be additionally transferred to the manager or the like and written on the ROM 62 or the auxiliary storage device 64 under operation by the manager, serviceman, or the like. The transfer of the program at this time can be realized, for example, by recording the program on a removable storage medium, such as a magnetic disk, a magneto-optical disk, an optical disc, or the semiconductor memory, or by downloading the program over a network or the like.

The scanner interface 65 is an interface with the scanner 1. The scanner interface 65 transmits a control signal for controlling the operation of the respective parts in the scanner 1, which is output from the processor 61, to the scanner 1. Moreover, the scanner interface 65 receives from the scanner an operation state signal indicating the image data of the original document or the operation state of the respective parts in the scanner 1 and inputs the operation state signal to the processor 61.

The printer interface 66 is an interface with the printer 2. The printer interface 66 transmits to the printer 2 a control signal for controlling the operation of the respective parts in the printer 2, which is output from the processor 61. Moreover, the printer interface 66 receives from the printer 2 an operation state signal indicating the operation state of the respective parts in the printer 2 and inputs the operation state signal to the processor 61.

The input/output interface 67 is an interface with the operation panel 4. The input/output interface 67 transmits to the operation panel 4 the contents displayed to the display device 4a, which is output from the processor 61. Moreover, the input/output interface 67 receives from the operation panel 4 information input to the touch panel 4b or buttons and inputs the information to the processor 61.

The RFID reader/writer interface 68 is interface with the RFID reader/writer 5. The RFID reader/writer interface 68 transmits to the RFID reader/writer 5 data that should be written to the RFID tag of the RFID paper Prf. Moreover, the RFID reader/writer interface 68 receives from the RFID reader/writer 5 data read by the RFID tag and inputs the data to the processor 61.

The communication interface 69 is a wired or wireless interface for communicating with a server apparatus or user terminal via a network or the like to receive from the server apparatus or user terminal data, such as image data indicating an image to be printed on the paper or data to be written to the RFID tag, and control information, such as selection of print paper and the number of prints.

The RTC 70 is a watch, a circuit with a watch function, or the like.

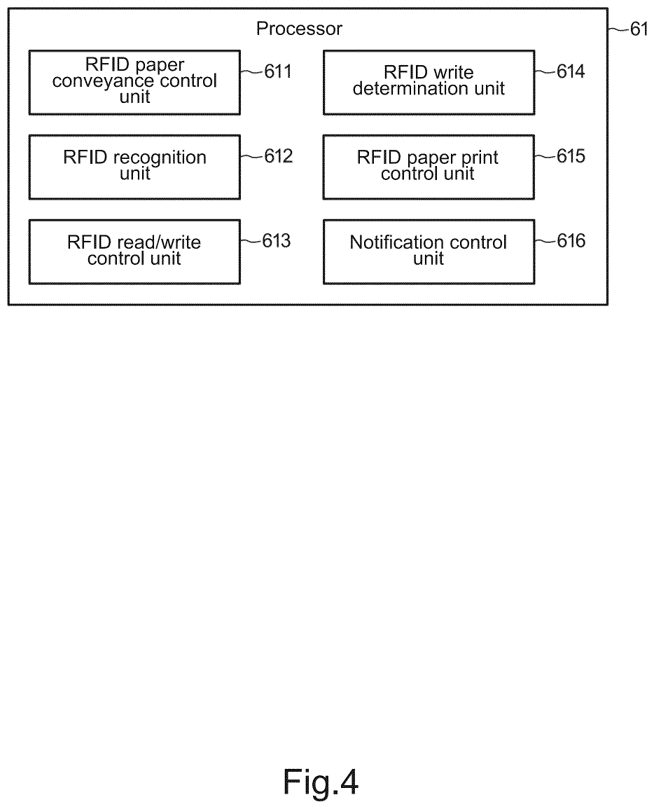

An example of a configuration of the processor 61 of the image forming apparatus 100 will be described with reference to FIG. 4. FIG. 4 is a block diagram showing an example of a configuration of the processor 61. The processor 61 includes an RFID paper conveyance control unit 611, an RFID recognition unit 612, an RFID read/write control unit 613, an RFID write determination unit 614, an RFID paper print control unit 615, and a notification control unit 616. The processor 61 realizes the functions of the respective parts of the RFID paper conveyance control unit 611, the RFID recognition unit 612, the RFID read/write control unit 613, the RFID write determination unit 614, the RFID paper print control unit 615, and the notification control unit 616 by executing the program stored in the ROM 62, the auxiliary storage device 64, or the like. It should be noted that the RFID paper conveyance control unit 611, the RFID recognition unit 612, the RFID read/write control unit 613, the RFID write determination unit 614, the RFID paper print control unit 615, and the notification control unit 616 may be realized by hardware, such as large scale integration (LSI), ASIC, and FPGA, which have functions similar to those of the processor 61 executing the program.

The RFID paper conveyance control unit 611 controls the conveyance of the RFID paper Prf by controlling driving of each roller and the like of the conveyance device 22 of the printer 2 via the printer interface 66.

The RFID recognition unit 612 controls the RFID reader/writer 5 via the RFID reader/writer interface 68 and controls reading of identification data including initial data, which is written in the EPC area of the RFID tag of the RFID paper Prf or the position-fixed tag TG. Then, the RFID recognition unit 612 recognizes the RFID tag on the basis of the identification data read from the EPC area, which is input from the RFID reader/writer 5. Moreover, in a case where the RFID recognition unit 612 has not successfully recognized the RFID tag, the RFID recognition unit 612 controls the RFID reader/writer 5 via the RFID reader/writer interface 68 to decrease the reception threshold of the radio signal strength to be returned from the RFID tag or increase the radio signal strength to be transmitted to the RFID tag and cause the RFID reader/writer 5 to re-read the identification data.

The RFID read/write control unit 613 controls the RFID reader/writer 5 via the RFID reader/writer interface 68 and controls writing of data into the user area of the recognized RFID tag of the RFID paper Prf and reading of data from the user area.

The RFID write determination unit 614 compares the data read by the RFID reader/writer 5 with data instructed to be written, thereby determining whether or not the writing has been successfully done. It should be noted that in a case where the RFID reader/writer 5 itself has a function of verifying writing data, the RFID write determination unit 614 may determine whether or not the writing is successfully done on the basis of a verification result input from the RFID reader/writer 5 via the RFID reader/writer interface 68 without checking the data.

The RFID paper print control unit 615 controls the printer 2 via the printer interface 66, thereby controlling print, i.e., image formation on the RFID paper Prf.

The notification control unit 616 notifies the user of a status of the RFID paper Prf in accordance with whether or not the data writing to the RFID tag has been successfully done in a case of decreasing the reception threshold of the radio signal strength to be returned from the RFID tag or increasing the radio signal strength to be transmitted to the RFID tag. Specifically, in a case where the writing has been successfully done, the notification control unit 616 causes the RFID paper conveyance control unit 611 to output the RFID paper Prf that is blank paper on which an arbitrary image is not printed, which is specified by the user, to the upper output tray 29B that is the second output part of the output part 29. Outputting this blank paper can notify the user that the RFID paper Prf is one having an RFID tag that is less responsive or difficult to recognize due to a manufacturing variation. Moreover, in a case where the writing has failed, the notification control unit 616 causes the RFID paper print control unit 615 to print not an arbitrary image specified by the user, but a predetermined incompatibility mark as the status of the RFID paper Prf on the RFID paper Prf, and then causes the RFID paper conveyance control unit 611 to output the RFID paper Prf to the upper output tray 29B. Printing this incompatibility mark can notify the user that the status of the RFID paper Prf is incompatible with the image forming apparatus 100. Moreover, the notification control unit 616 causes the display device 4a of the operation panel 4 to display the status of the RFID paper Prf via the input/output interface 67.

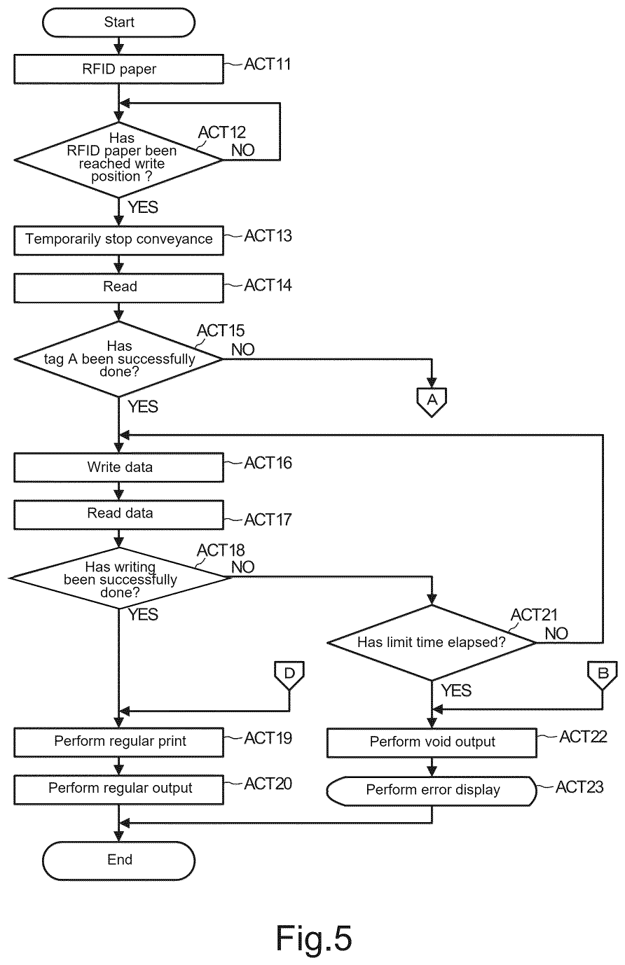

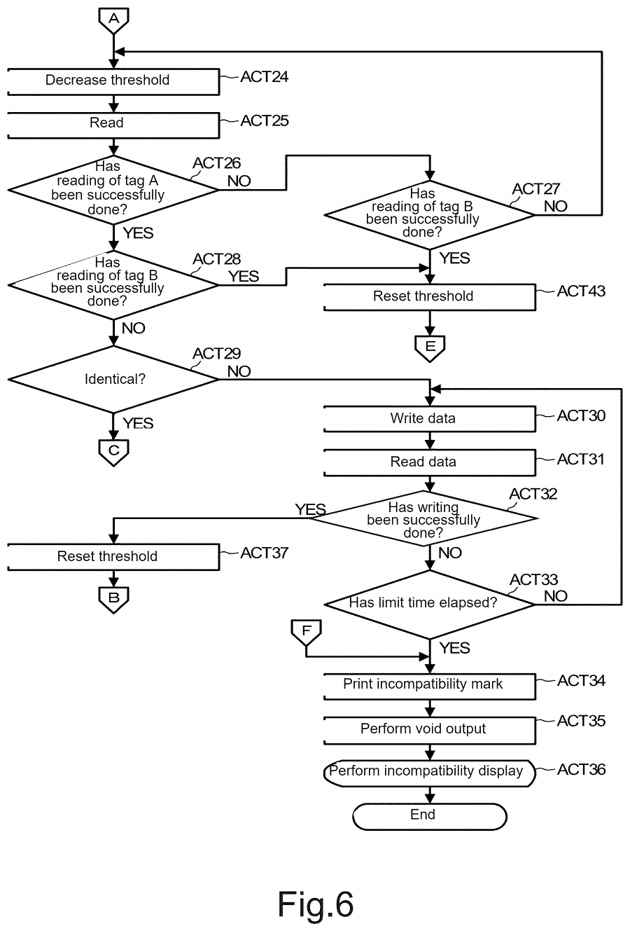

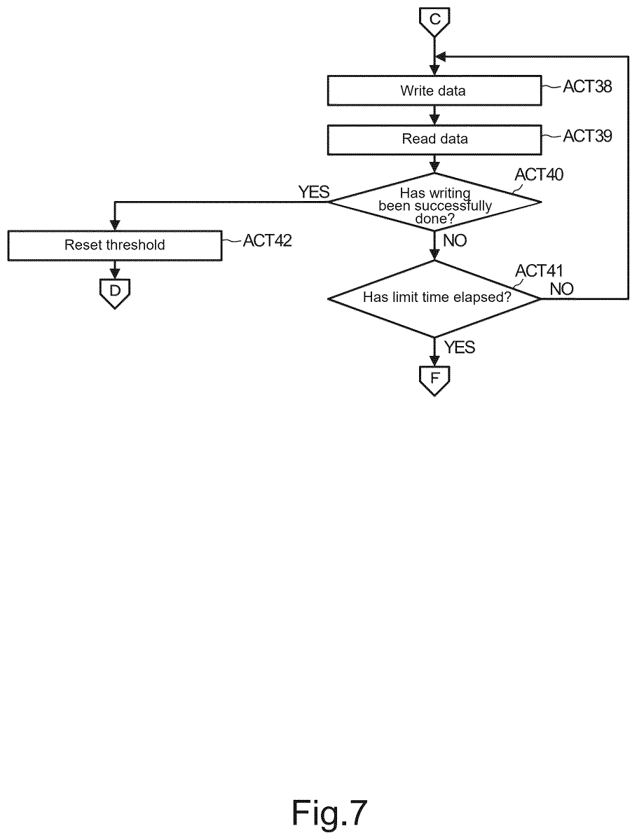

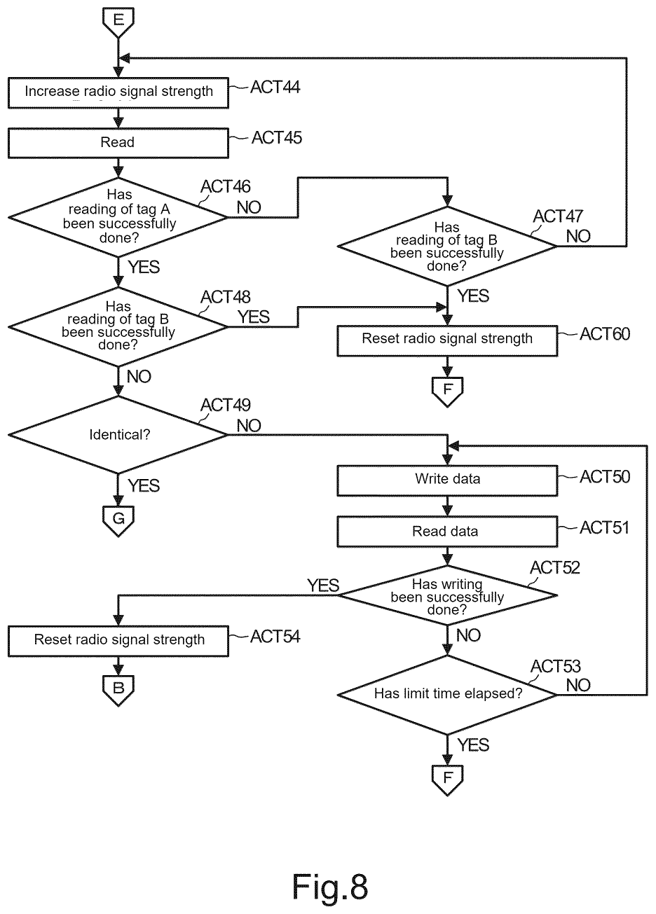

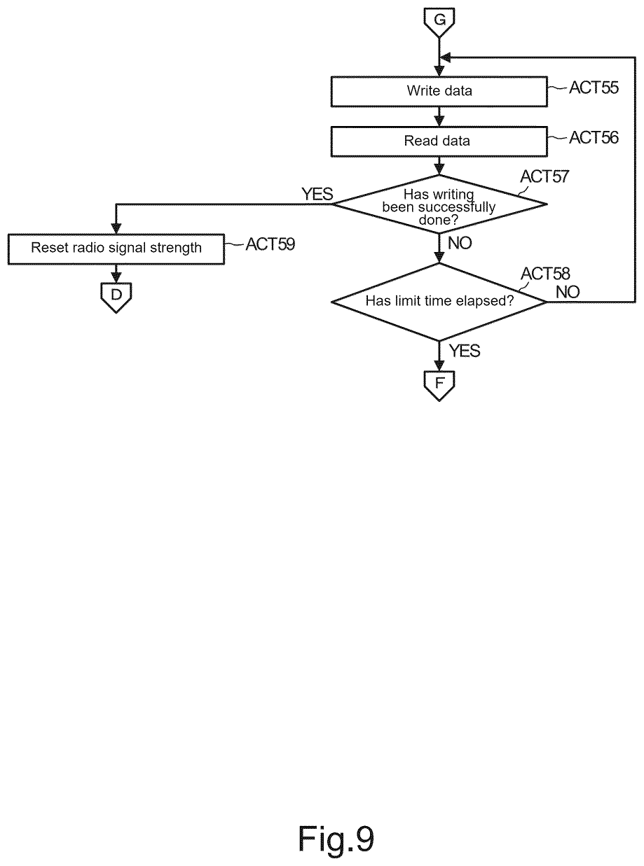

Hereinafter, an operation of the image forming apparatus 100 according to the embodiment will be described with reference to FIGS. 5 to 9. It should be noted that the contents of processing in the following operation description are examples, and various types of processing that can provide the same effects may be used as appropriate.

FIGS. 5 to 9 show a series of flowcharts showing an example of RFID processing associated with data writing and printing on the RFID paper Prf in the operation of the image forming apparatus according to the embodiment. The processor 61 executes this processing on the basis of the program stored in the ROM 62, the auxiliary storage device 64, or the like. It should be noted that the processing of the processor 61 transitions to ACT (x+1) after ACT x (x denotes a natural number) unless otherwise stated.

The image forming apparatus 100 starts the processing shown in FIG. 5 when the image forming apparatus 100 receives arbitrary image data indicating an image to be printed on the RFID paper Prf and arbitrary user data to be written to the RFID tag of the RFID paper Prf through the communication interface 69 from the server apparatus or user terminal. It should be noted that the received image data and user data can be stored in the RAM 63 or the auxiliary storage device 64.

In ACT 11, the processor 61 operates as the RFID paper conveyance control unit 611 and controls the printer 2 via the printer interface 66, thereby conveying the RFID paper Prf. For example, in the example shown in FIG. 1, the processor 61 causes the pick-up roller 21A to take out one sheet of RFID paper Prf set in the paper feed cassette 20A and convey the RFID paper Prf to the resist rollers 23.

In ACT 12, the processor 61 determines whether or not the RFID paper Prf has reached the write position. In the present embodiment, the write position corresponds to the position of the resist rollers 23. Therefore, here, the processor 61 determines whether or not the RFID paper Prf conveyed in the conveyance device 22 has reached the resist rollers 23. For example, the image forming apparatus 100 can have a detector for detecting that the paper has reached the resist rollers 23, such as a mechanical switch or an optical sensor. The processor 61 is capable of performing the determination in ACT 12 by obtaining the output of the detector via the printer interface 66. On the basis of the determination that the RFID paper Prf has not reached the write position (NO in ACT 12), the processor 61 repeats the processing operation in ACT 12. In this manner, the processor 61 waits for the RFID paper Prf to reach the resist rollers 23.

On the basis of the determination that the RFID paper Prf has reached the write position (YES in ACT 12), the processor 61 controls the conveyance device 22 of the printer 2 via the printer interface 66 in ACT 13, thereby temporarily stopping the conveyance of the RFID paper Prf.

In ACT 14, the processor 61 operates as the RFID recognition unit 612 and reads an RFID tag (hereinafter, referred to as tag A) of the RFID paper Prf. Specifically, the processor 61 instructs the RFID module 51 of the RFID reader/writer 5 to read the data written to the tag A via the RFID reader/writer interface 68. In response to this instruction, the RFID module 51 of the RFID reader/writer 5 emits an electromagnetic wave for reading the data written to the tag A of the RFID paper Prf stopped at the write position from the antenna 52 for a prescribed time. The tag A receives this electromagnetic wave, thereby emitting the data recorded on the storage region. The RFID module 51 outputs the data received from the tag A by the antenna 52 as read data. The processor 61 obtains read data output from the RFID module 51 of the RFID reader/writer 5 via the RFID reader/writer interface 68.

In ACT 15, the processor 61 determines whether or not the reading of the data from the tag A of the RFID paper Prf has been successfully done, i.e., whether or not the processor 61 has recognized the tag A. Specifically, the processor 61 determines whether or not the processor 61 has read initial data included in the identification data written in the EPC area of the tag A as read data obtained from the RFID reader/writer 5 via the RFID reader/writer interface 68. In a case where the processor 61 has successfully read the initial data, the processor 61 can recognize what kind of RFID tag the tag A is. On the basis of the determination that the processor 61 has failed to read the initial data, i.e., the reading of the tag A has failed (NO in ACT 15), the processor 61 shifts to the processing operation in ACT 24 to be described later.

On the basis of the determination that the reading of the tag A has been successfully done (YES in ACT 15), in ACT 16, the processor 61 operates as the RFID read/write control unit 613 and writes data to the RFID tag of the RFID paper Prf. Specifically, the processor 61 transmits, to the RFID module 51 of the RFID reader/writer 5 via the RFID reader/writer interface 68, user data that should be written to the RFID tag of the RFID paper Prf and identification data related to the user data, which are stored in the RAM 63 or the auxiliary storage device 64. The RFID module 51 of the RFID reader/writer 5 that has received that data executes writing to the tag A of the RFID paper Prf stopped at the write position. Specifically, the RFID module 51 emits an electromagnetic wave for writing data that is writing information through the antenna 52. By receiving this electromagnetic wave, the RFID tag of the RFID paper Prf writes the user data in the user area included in the electromagnetic wave and writes the identification data in the EPC area.

In ACT 17, the processor 61 reads the data written to the RFID tag of the RFID paper Prf. Specifically, the processor 61 instructs the RFID reader/writer 5 to read the data from the RFID tag of the RFID paper Prf via the RFID reader/writer interface 68. In response to this instruction, the RFID module 51 of the RFID reader/writer 5 emits an electromagnetic wave for reading the data written to the RFID tag from the antenna 52 for a prescribed time. By receiving this electromagnetic wave, the RFID tag emits the data recorded on the storage region. The RFID module 51 outputs the data received from the RFID tag through the antenna 52 as read data. The processor 61 obtains the read data output from the RFID module 51 of the RFID reader/writer 5 via the RFID reader/writer interface 68.

In ACT 18, the processor 61 operates as the RFID write determination unit 614 and determines whether or not the data writing to the RFID tag of the RFID paper Prf has been successfully done. Specifically, the processor 61 compares the read user data input from the RFID reader/writer 5 via the RFID reader/writer interface 68 with the user data instructed to be written, which is stored in the RAM 63 or the auxiliary storage device 64, thereby determining whether the data writing has been successfully done or failed. On the basis of the determination that the data writing has not been successfully done, i.e., the data writing has failed (NO in ACT 18), the processor 61 shifts to the processing operation in ACT 21 to be described later.

On the basis of the determination that the data writing has been successfully done (YES in ACT 18), in ACT 19, the processor 61 operates as the notification control unit 616 and causes the RFID paper conveyance control unit 611 and the RFID paper print control unit 615 to perform regular print. Specifically, the processor 61 operates as the RFID paper print control unit 615 and causes the image forming unit 24 of the printer 2 to transfer (primarily transfer) an toner image according to the image data stored in the RAM 63 or the auxiliary storage device 64 onto the transfer belt 26 via the printer interface 66. In addition, the processor 61 operates as the RFID paper conveyance control unit 611 and restarts the conveyance of the RFID paper Prf temporarily stopped at the position of the resist rollers 23 that is the write position. Specifically, the processor 61 restarts driving of each roller of the conveyance device 22 of the printer 2 via the printer interface 66. Accordingly, at a timing of transferring the image from the transfer belt 26 to the RFID paper Prf, the RFID paper Prf temporarily conveyed to the transfer position and the toner image transferred onto the transfer belt 26 is secondarily transferred onto the RFID paper Prf. In this manner, the image is printed on the RFID paper Prf on which the data is written at the RFID tag.

In ACT 20, the processor 61 operates as the RFID paper conveyance control unit 611 and regularly outputs the RFID paper Prf on which the data has been written at the RFID tag and the image has been printed. Specifically, the processor 61 switches the flapper 22E in the conveyance device 22 of the printer 2 toward the lower output tray 29A that is the first output part of the output part 29 via the printer interface 66 in order to set a first conveyance path as a conveyance path for the RFID paper Prf. Accordingly, the RFID paper Prf on which the data has been written at the RFID tag and the image has been printed is conveyed on the first conveyance path and is output to the lower output tray 29A.

Then, the processor 61 terminates the processing shown in this flowchart. It should be noted that this is RFID processing in a case where the image formation and the data writing are specified for one sheet of RFID paper Prf. For example, in a case where the same image formation and data writing are specified for a plurality of sheets of RFID paper Prf or in a case where different image formation and data writing are specified for the plurality of sheets of RFID paper Prf, whether or not the processing is completed is determined, and if an unformed image or unwritten data has been stored in the RAM 63 or the auxiliary storage device 64, the processing operation in ACT 11 and the subsequent steps are repeated.

On the basis of the determination in ACT 18 that the data writing has failed (NO in ACT 18), in ACT 21, the processor 61 determines whether or not the limit time has elapsed. Specifically, the processor 61 counts an elapse time from the time when it is determined that the reading of the tag A has been successfully done in ACT 15 through the RTC 70 and determines whether or not the elapse time has exceeded the limit time. On the basis of the determination that the limit time has not elapsed (NO in ACT 21), the processor 61 shifts to the processing operation in ACT 16. In this manner, the data writing and reading are retried until the limit time elapses.

On the basis of the determination that the limit time has elapsed (YES in ACT 21), in ACT 22, the processor 61 operates as the notification control unit 616 and causes the RFID paper conveyance control unit 611 and the RFID paper print control unit 615 to print an error mark on the RFID paper Prf. Specifically, the processor 61 operates as the RFID paper print control unit 615 and causes the RFID paper conveyance control unit 611 to perform void output. In this specification, the void output means outputting paper to a position different from that in the regular output. Specifically, the processor 61 switches the flapper 22E in the conveyance device 22 of the printer 2 toward the upper output tray 29B that is the second output part of the output part 29 via the printer interface 66 in order to set a second conveyance path as the conveyance path for the RFID paper Prf. Accordingly, the conveyance of the RFID paper Prf temporarily stopped at the position of the resist rollers 23, which is the write position, is restarted and the RFID paper Prf is conveyed on the second conveyance path and is output to the upper output tray 29B.

In ACT 23, the processor 61 operates as the notification control unit 616 and performs error display on the display device 4a of the operation panel 4. Specifically, the processor 61 causes the display device 4a to display what status the RFID paper Prf that is the blank paper output to the upper output tray 29B is in via the input/output interface 67. The data writing and reading to/from the RFID tag may fail due to a malfunction of the RFID tag. However, the tag A has been successfully recognized in ACT 15. Although there is no problem with the EPC area of the tag A, the possibility of a problem in the user area cannot be ruled out, but the possibility of the malfunction of the RFID tag is low. In view of this, for example, the error display indicates that the paper output as blank paper has an RFID tag that is less responsive or difficult to recognize than usual, and that there may be an impact on the use of the paper by the user. If the user still wishes to use the paper, a description text to prompt the user to set the paper in the paper feed cassette again is displayed. It should be noted that it is needless to say that the manual for this image forming apparatus 100 also includes a description of the case of outputting the blank paper.

Then, the processor 61 terminates the processing shown in this flowchart. It should be noted that as described above, for example, in a case where the same image formation and data writing are specified for the plurality of sheets of RFID paper Prf or in a case where different image formation and data writing are specified for the plurality of sheets of RFID paper Prf, whether or not the processing is completed is determined. The error display in ACT 23 may be performed only one time when it is determined that the processing is completed rather than performing such error display every void output in ACT 22.

Moreover, on the basis of the determination in ACT 15 that the reading of the tag A has failed (NO in ACT 15), in ACT 24, the processor 61 operates as the RFID recognition unit 612 and decreases the reception threshold of the radio signal strength to be returned from the RFID tag. Specifically, the processor 61 sends an instruction to decrease the reception threshold by one level to the RFID module 51 of the RFID reader/writer 5 via the RFID reader/writer interface 68. After receiving this instruction, the RFID module 51 decreases the reception threshold by one level.

In ACT 25, the processor 61 reads the tag A of the RFID paper Prf as in the processing operation in ACT 14.

In ACT 26, the processor 61 determines whether or not the reading of the data from the tag A of the RFID paper Prf has been successfully done, i.e., whether or not the tag A has been recognized as in the processing operation in ACT 15. On the basis of the determination that the reading of the tag A has been successfully done (YES in ACT 26), the processor 61 shifts to the processing operation in ACT 28 to be described later.

On the basis of the determination that the reading of the tag A has failed (NO in ACT 26), in ACT 27, the processor 61 determines whether or not reading of a position-fixed tag TG (hereinafter, referred to as tag B) has been successfully done. On the basis of the determination that the reading of the tag B has been successfully done (YES in ACT 27), the processor 61 shifts to the processing operation in ACT 39 to be described later. Moreover, on the basis of the determination that the reading of the tag B has failed (NO in ACT 27), the processor 61 shifts to the processing operation in ACT 24. In this manner, the reception threshold of the radio signal strength to be returned from the RFID tag is stepwisely decreased until the reading of the tag A or tag B is successfully done.

On the basis of the determination in ACT 26 that the reading of the tag A has been successfully done (YES in ACT 26), in ACT 28, the processor 61 determines whether or not the reading of the tag B has been successfully done. If the reception threshold of the radio signal strength to be returned from the RFID tag is one that realizes the access limit region ER1 when the user attempts to read the tag A in ACT 25, the tag B is also read. There is thus a possibility that the tags A and B are simultaneously read. On the basis of the determination that the reading of the tag B has been successfully done, i.e., reading of both the tags A and B has been successfully done (YES in ACT 28), the processor 61 shifts to the processing operation in ACT 43 to be described later.

On the basis of the determination that the reading of the tag B has failed, i.e., the reading of only the tag A has been successfully done (NO in ACT 28), in ACT 29, the processor 61 determines in ACT 25 via the RFID reader/writer interface 68 whether or not the identification data included in the read data reader/writer 5 identical to obtained from the RFID is identification data indicating an ID indicating that the RFID tag is a tag that is difficult to recognize due to a manufacturing variation (arbitrary ID indicating the manufacturing number and the manufacturing variation, e.g., a sequence of numbers of 1 to 9 arranged in order repeatedly), which is stored in the RAM 63 or the auxiliary storage device 64. On the basis of the determination that the identification data is identical (YES in ACT 29), the processor 61 shifts to the processing operation in ACT 38 to be described later.

On the basis of the determination in ACT 29 that the identification data is not identical, i.e., the user data written to the tag A is different from user data that should be written to the RFID tag of the RFID paper Prf (NO in ACT 29), in ACT 30, the processor 61 operates as the RFID read/write control unit 613 and writes data to the tag A of the RFID paper Prf as in the processing operation in ACT 16. Specifically, the processor 61 writes the user data in the user area of the tag A and writes the identification data in the EPC area. For example, the identification data can include an ID indicating that the RFID tag is a tag that is difficult to recognize due to a manufacturing variation (arbitrary ID indicating the manufacturing number and the manufacturing variation, e.g., a sequence of numbers of 1 to 9 arranged in order repeatedly) and threshold data indicating the reception threshold of the radio signal strength to be returned from the RFID tag, which has been set in ACT 24.

In ACT 31, the processor 61 reads the data written to the tag A of the RFID paper Prf as in the processing operation in ACT 17. At this time, the RFID module 51 of the RFID reader/writer 5 has the reception threshold of the radio signal strength to be returned from the RFID tag, which has been set in ACT 24.

In ACT 32, the processor 61 operates as the RFID write determination unit 614 and determines whether or not the data writing to the tag A of the RFID paper Prf has been successfully done, as in the processing operation in ACT 18. On the basis of the determination that the data writing has been successfully done (YES in ACT 32), the processor 61 shifts to the processing operation in ACT 34 to be described later.

On the basis of the determination that the data writing has not been successfully done, i.e., the data writing has failed (NO in ACT 32), in ACT 33, the processor 61 determines whether or not the limit time has elapsed as in the processing operation in ACT 21. On the basis of the determination that the limit time has not elapsed (NO in ACT 33), the processor 61 shifts to the processing operation in ACT 30. In this manner, the data writing and reading are retried until the limit time elapses.

On the basis of the determination in ACT 33 that the limit time has elapsed (YES in ACT 33), in ACT 34, the processor 61 operates as the notification control unit 616 and causes the RFID paper conveyance control unit 611 and the RFID paper print control unit 615 to print an incompatibility mark on the RFID paper Prf. Specifically, the processor 61 operates as the RFID paper print control unit 615 and causes the image forming unit 24 of the printer 2 to transfer (primarily transfer) a toner image according to the image data of the incompatibility mark indicating that the RFID tag of the RFID paper Prf is incompatible with the image forming apparatus 100 onto the transfer belt 26 via the printer interface 66. For example, the incompatibility mark may be directly the characters, “INCOMPATIBLE,” or may be a diagonal line. In addition, the processor 61 operates as the RFID paper conveyance control unit 611 and restarts the conveyance of the RFID paper Prf temporarily stopped at the position of the resist rollers 23 that is the write position. Specifically, the processor 61 restarts driving of each roller of the conveyance device 22 of the printer 2 via the printer interface 66. Accordingly, at a timing of transferring the image from the transfer belt 26 to the RFID paper Prf, the RFID paper Prf temporarily stopped is conveyed to the transfer position and the toner image transferred onto the transfer belt 26 is secondarily transferred onto the RFID paper Prf. In this manner, the image of the incompatibility mark is printed on the RFID paper Prf. It should be noted that the printing position of the incompatibility mark is desirably set to be such a position that it is unlikely to affect the reuse of the RFID paper Prf, for example, any one of the four corners of the RFID paper Prf.

In ACT 35, the processor 61 performs the void output on the RFID paper Prf on which the image of the incompatibility mark is printed as in ACT 22. Accordingly, the RFID paper Prf on which the image of the incompatibility mark is printed is conveyed on the second conveyance path and is output to the upper output tray 29B.

In ACT 36, the processor 61 operates as the notification control unit 616 and performs incompatibility display on the display device 4a of the operation panel 4. Specifically, the processor 61 causes the display device 4a to display that that the RFID tag of the RFID paper Prf output to the upper output tray 29B cannot be used in this image forming apparatus 100 or that the incompatibility mark printed on the RFID paper Prf shows that the RFID tag of the RFID paper Prf is unusable via the input/output interface 67. It should be noted that it is needless to say that the manual for this image forming apparatus 100 also includes a description of the case of printing the incompatibility mark.

The RFID paper Prf may be incompatible with the image forming apparatus 100 due to a malfunction of the RFID tag. However, since the tag A is recognized in ACT 26, the status of the RFID paper Prf in this case is that the RFID tag of the RFID paper Prf is difficult to recognize due to a manufacturing variation, not a malfunction. Therefore, if the reception threshold is further decreased and the data writing and reading are performed, the data writing might be successfully done. However, it will take time, and the user's waiting time will increase. Therefore, here, it is desirable to shift to processing on another RFID paper Prf, considering that the current RFID paper Prf is incompatible.

Then, the processor 61 terminates the processing shown in this flowchart. Also in this case, if the same image formation and data writing are specified for the plurality of sheets of RFID paper Prf or different image formation and data writing are specified for the plurality of sheets of RFID paper Prf, whether or not the processing is completed is determined. The incompatibility display in ACT 36 may be performed only one time when it is determined that the processing is completed rather than performing such incompatibility display every void output in ACT 36. Moreover, in this case, the RFID paper Prf output to the upper output tray 29B may include both blank paper and those with the incompatibility mark printed thereon. In such case, both the error display and the incompatibility display in ACT 36 may be performed only one time to display each meaning.

Moreover, on the basis of the determination in ACT 32 that the data writing has been successfully done (YES in ACT 32), in ACT 37, the processor 61 operates as the RFID recognition unit 612 and resets the reception threshold of the radio signal strength to be returned from the RFID tag to the prescribed value. Then, the processor shifts to the processing operation in ACT 22.

In this manner, if the processor 61 recognizes only the tag A in the process of stepwisely decreasing the radio signal strength, the processor 61 writes the identification data and the user data to the tag A, and then outputs the RFID paper Prf to the upper output tray 29B as blank paper. In general, the user who uses the RFID paper Prf on which the data has been written at the RFID tag and the image has been printed reads the user data from the RFID tag of the RFID paper Prf through the RFID reader set to have a reception threshold smaller than the minimum reception threshold used by the image forming apparatus 100. Therefore, even if the image is printed on the RFID paper Prf output as blank paper in this manner and provided to the user, the user can use the user data with a high possibility. Therefore, the user of the image forming apparatus 100 sets the RFID paper Prf output as blank paper in this manner to the paper feed cassette 20A or the manual feed tray 20D again without discarding the RFID paper Prf.

In this manner, with respect to the RFID paper Prf set again, the processor 61 shifts to the processing operation in ACT 29 through the processing operation in ACT 11 to ACT 15 and ACT 24 to ACT 28 as described above. Then, on the basis of the determination in ACT 29 that the identification data is not identical, i.e., the identification data written to the tag A is different from the identification data indicating the ID indicating that the RFID tag is a tag that is difficult to recognize due to a manufacturing variation (arbitrary ID indicating the manufacturing number and the manufacturing variation, e.g., a sequence of numbers of 1 to 9 arranged in order repeatedly) (NO in ACT 29), the processor 61 shifts to the processing operation in ACT 30. At a time when the RFID paper Prf output as blank paper set to the paper feed cassette 20A or the manual feed tray 20D again is actually used, other user data that should be written may be already specified. In such a case, the processor 61 will shift to writing the specified user data.

Otherwise, on the basis of the determination in ACT 29 that the identification data written to the tag A is identical to the identification data indicating the ID indicating that the RFID tag is a tag that is difficult to recognize due to a manufacturing variation (arbitrary ID indicating the manufacturing number and the manufacturing variation, e.g., a sequence of numbers of 1 to 9 arranged in order repeatedly) (YES in ACT 29), the processor 61 shifts to the processing operation in ACT 38. In ACT 38, the processor 61 operates as the RFID read/write control unit 613 and writes data to the tag A of the RFID paper Prf, as in the processing operation in ACT 30.

In ACT 39, the processor 61 reads the data written to the tag A of the RFID paper Prf as in the processing operation in ACT 31. At this time, the RFID module 51 of the RFID reader/writer 5 has the reception threshold of the radio signal strength to be returned from the RFID tag, which has been set in ACT 24.

In ACT 40, the processor 61 operates as the RFID write determination unit 614 and determines whether or not the data writing to the tag A of the RFID paper Prf has been successfully done, as in the processing operation in ACT 32. On the basis of the determination that the data writing has been successfully done (YES in ACT 40), the processor 61 shifts to the processing operation in ACT 42 to be described later.

On the basis of the determination that the data writing has not been successfully done, i.e., the data writing has failed (NO in ACT 40), in ACT 41, the processor 61 determines whether or not the limit time has elapsed as in the processing operation in ACT 33. On the basis of the determination that the limit time has not elapsed (NO in ACT 41), the processor 61 shifts to the processing operation in ACT 38. In this manner, the data writing and reading are retried until the limit time elapses.

On the basis of the determination in ACT 41 that the limit time has elapsed (YES in ACT 41), the processor 61 shifts to the processing operation in ACT 34. Accordingly, the incompatibility mark is printed on the RFID paper Prf and is conveyed on the second conveyance path and output to the upper output tray 29B.

Moreover, on the basis of the determination in ACT 39 that the data writing has been successfully done (YES in ACT 39), in ACT 42, the processor 61 operates as the RFID recognition unit 612 and resets the reception threshold of the radio signal strength to be returned from the RFID tag to the prescribed value. Then, the processor shifts to the processing operation in ACT 19. Accordingly, the image is printed on the RFID paper Prf and is output to the lower output tray 29A.

Moreover, if the reception threshold of the radio signal strength to be returned from the RFID tag is one that realizes the access limit region ER1 when the user attempts to read the tag A in ACT 25, the tag B is also read. In this case, it is determined in ACT 27 that the reading of the tag B has been successfully done (YES in ACT 27) or it is determined in ACT 28 that the reading of the tag B has been successfully done (YES in ACT 28). On the basis of the determination that the reading of the tag B has been successfully done, in ACT 43, the processor 61 operates as the RFID recognition unit 612 and resets the reception threshold of the radio signal strength to be returned from the RFID tag to the prescribed value. Then, the processor shifts to the processing operation in ACT 44.

In ACT 44, the processor 61 operates as the RFID recognition unit 612 and increases the radio signal strength to be transmitted to the RFID tag. Specifically, the processor 61 transmits an instruction to increase the radio signal strength to be transmitted by one level to the RFID module 51 of the RFID reader/writer 5 via the RFID reader/writer interface 68. After receiving this instruction, the RFID module 51 increases the radio signal strength to be transmitted by one level.

In ACT 45, the processor 61 reads the tag A of the RFID paper Prf as in the processing operation in ACT 25. The reception threshold of the radio signal strength to be returned from the RFID tag in the RFID module 51 of the RFID reader/writer 5 at this time is the prescribed value.

In ACT 46, the processor 61 determines whether or not the reading of the data from the tag A of the RFID paper Prf has been successfully done, i.e., whether or not the tag A has been recognized, as in the processing operation in ACT 26. On the basis of the determination that the reading of the tag A has been successfully done (YES in ACT 46), the processor 61 shifts to the processing operation in ACT 48 to be described later.

On the basis of the determination that the reading of the tag A has failed (NO in ACT 46), in ACT 47, the processor 61 determines whether or not the reading of the tag B has been successfully done as in the processing operation in ACT 27. On the basis of the determination that the reading of the tag B has been successfully done (YES in ACT 47), the processor 61 shifts to the processing operation in ACT 60 to be described later. Moreover, on the basis of the determination that the reading of the tag B has failed (NO in ACT 47), the processor 61 shifts to the processing operation in ACT 44. In this manner, the radio signal strength to be transmitted to the RFID tag is stepwisely increased until the reading of the tag A or tag B is successfully done.

On the basis of the determination in ACT 46 that the reading of the tag A has been successfully done (YES in ACT 46), in ACT 48, the processor 61 determines whether or not the reading of the tag B has been successfully done as in the processing operation in ACT 28. If the radio signal strength to be transmitted to the RFID tag is one that realizes the access limit region ER1 when the user attempts to read the tag A in ACT 45, the tag B is also read. There is thus a possibility that the tags A and B are simultaneously read. On the basis of the determination that the reading of the tag B has been successfully done, i.e., reading of both the tags A and B has been successfully done (YES in ACT 48), the processor 61 shifts to the processing operation in ACT 60 to be described later.

On the basis of the determination that the reading of the tag B has failed, i.e., the reading of only the tag A has been successfully done (NO in ACT 48), in ACT 49, as in ACT 29, the processor 61 determines whether or not the identification data included in the read data obtained from the RFID reader/writer 5 via the RFID reader/writer interface 68 in ACT 45 is identical to the identification data indicating the ID indicating that the RFID tag is a tag that is difficult to recognize due to a manufacturing variation, which is stored in the RAM 63 or the auxiliary storage device 64 (arbitrary ID indicating the manufacturing number and the manufacturing variation, e.g., a sequence of numbers of 1 to 9 arranged in order repeatedly). On the basis of the determination that the identification data is identical (YES in ACT 49), the processor 61 shifts to the processing operation in ACT 55 to be described later.

On the basis of the determination in ACT 49 that the identification data is not identical, i.e., the identification data written to the tag A is different from the identification data indicating the ID indicating that the RFID tag is a tag that is difficult to recognize due to a manufacturing variation (arbitrary ID indicating the manufacturing number and the manufacturing variation, e.g., a sequence of numbers of 1 to 9 arranged in order repeatedly) (NO in ACT 49), in ACT 50, the processor 61 operates as the RFID read/write control unit 613 and writes data to the tag A of the RFID paper Prf, as in the processing operation in ACT 30. At this time, the RFID module 51 of the RFID reader/writer 5 has the radio signal strength to be transmitted to the RFID tag, which has been set in ACT 44. Specifically, the processor 61 writes the user data in the user area of the tag A and writes the identification data in the EPC area. For example, the identification data can include an ID indicating that the RFID tag is a tag that is less responsive due to a manufacturing variation (arbitrary ID indicating the manufacturing number and the manufacturing variation, e.g., a sequence of numbers of 1 to 9 arranged in order repeatedly) and radio signal strength data indicating the radio signal strength to be transmitted to the RFID tag, which has been set in ACT 44.

In ACT 51, the processor 61 reads the data written to the tag A of the RFID paper Prf as in the processing operation in ACT 31. The reception threshold of the radio signal strength to be returned from the RFID tag in the RFID module 51 of the RFID reader/writer 5 at this time is the prescribed value.

In ACT 52, the processor 61 operates as the RFID write determination unit 614 and determines whether or not the data writing to the tag A of the RFID paper Prf has been successfully done, as in the processing operation in ACT 32. On the basis of the determination that the data writing has been successfully done (YES in ACT 52), the processor 61 shifts to the processing operation in ACT 54 to be described later.

On the basis of the determination that the data writing has not been successfully done, i.e., the data writing has failed (NO in ACT 52), in ACT 53, the processor 61 determines whether or not the limit time has elapsed as in the processing operation in ACT 33. On the basis of the determination that the limit time has not elapsed (NO in ACT 53), the processor 61 shifts to the processing operation in ACT 50. In this manner, the data writing and reading are retried until the limit time elapses.

On the basis of the determination in ACT 52 that the data writing has been successfully done (YES in ACT 52), in ACT 54, the processor 61 operates as the RFID recognition unit 612 and resets the radio signal strength to be transmitted to the RFID tag to the prescribed value. Then, the processor shifts to the processing operation in ACT 22.

In this manner, if the processor 61 recognizes only the tag A in the process of stepwisely increasing the radio signal strength to be transmitted to the RFID tag, the processor 61 writes the identification data and the user data to the tag A, and then outputs the RFID paper Prf to the upper output tray 29B as blank paper. In general, the user who uses the RFID paper Prf on which the data has been written at the RFID tag and the image has been printed reads the user data from the RFID tag of the RFID paper Prf through the RFID reader set to have radio signal strength stronger than the maximum transmission radio signal strength used by the image forming apparatus 100. Therefore, even if the image is printed on the RFID paper Prf output as blank paper in this manner and provided to the user, the user can use the user data with a high possibility. Therefore, the user of the image forming apparatus 100 sets the RFID paper Prf output as blank paper in this manner to the paper feed cassette 20A or the manual feed tray 20D again without discarding the RFID paper Prf.

In this manner, with respect to the RFID paper Prf set again, the processor 61 shifts to the processing operation in ACT 49 through the processing operation in ACT 11 to ACT 15, ACT 24 to ACT 27, and ACT 43 to ACT 48 as described above. Then, on the basis of the determination in ACT 49 that the identification data is not identical, i.e., the identification data written to the tag A is different from the identification data indicating the ID indicating that the RFID tag is a tag that is difficult to recognize due to a manufacturing variation (arbitrary ID indicating the manufacturing number and the manufacturing variation, e.g., a sequence of numbers of 1 to 9 arranged in order repeatedly) (NO in ACT 49), the processor 61 shifts to the processing operation in ACT 50.

Otherwise, on the basis of the determination in ACT 49 that the identification data written to the tag A is identical to the identification data indicating the ID indicating that the RFID tag is a tag that is difficult to recognize due to a manufacturing variation (arbitrary ID indicating the manufacturing number and the manufacturing variation, e.g., a sequence of numbers of 1 to 9 arranged in order repeatedly) (YES in ACT 49), the processor 61 shifts to the processing operation in ACT 55. In ACT 55, the processor 61 operates as the RFID read/write control unit 613 and writes data to the tag A of the RFID paper Prf, as in the processing operation in ACT 50.

In ACT 56, the processor 61 reads the data written to the tag A of the RFID paper Prf as in the processing operation in ACT 51. At this time, the RFID module 51 of the RFID reader/writer 5 has the radio signal strength to be transmitted to the RFID tag, which has been set in ACT 44.

In ACT 57, the processor 61 operates as the RFID write determination unit 614 as in the processing operation in ACT 52 and determines whether or not the data writing to the tag A of the RFID paper Prf has been successfully done. On the basis of the determination that the data writing has been successfully done (YES in ACT 57), the processor 61 shifts to the processing operation in ACT 59 to be described later.

On the basis of the determination that the data writing has not been successfully done, i.e., the data writing has failed (NO in ACT 57), in ACT 58, the processor 61 determines whether or not the limit time has elapsed as in the processing operation in ACT 53. On the basis of the determination that the limit time has not elapsed (NO in ACT 58), the processor 61 shifts to the processing operation in ACT 55. In this manner, the data writing and reading are retried until the limit time elapses.

On the basis of the determination in ACT 58 that the limit time has elapsed (YES in ACT 58), the processor 61 shifts to the processing operation in ACT 34. Accordingly, the incompatibility mark is printed on the RFID paper Prf and is conveyed on the second conveyance path and output to the upper output tray 29B.

Moreover, on the basis of the determination in ACT 57 that the data writing has been successfully done (YES in ACT 57), in ACT 59, the processor 61 operates as the RFID recognition unit 612 and resets the radio signal strength to be transmitted to the RFID tag to the prescribed value. Then, the processor shifts to the processing operation in ACT 19. Accordingly, the image is printed on the RFID paper Prf and is output to the lower output tray 29A.

Moreover, on the basis of the determination in ACT 53 that the limit time has elapsed (YES in ACT 53), the processor 61 shifts to the processing operation in ACT 34. Accordingly, the RFID paper Prf is printed with the incompatibility mark, conveyed on the second conveyance path, and output to the upper output tray 29B and the incompatibility display is performed on the display device 4a of the operation panel 4.

Moreover, if the radio signal strength to be transmitted to the RFID tag is one that realizes the access limit region ER1 when the user attempts to read the tag A in ACT 45, the tag B is also read. In this case, it is determined in ACT 48 that the reading of the tag B has been successfully done (YES in ACT 48) or it is determined in ACT 47 that the reading of the tag B has been successfully done (YES in ACT 47). It should be noted that in particular, in a case where it is determined in ACT 48 that the tag B as well as the tag A are simultaneously recognized, when the radio signal strength is transmitted to the tag A for data writing, data is also written to the tag other than the tag A. It is thus necessary to avoid shifting to the processing operation in ACT 50. Therefore, on the basis of the determination that the reading of the tag B has been successfully done, in ACT 60, the processor 61 operates as the RFID recognition unit 612 and resets the radio signal strength to be transmitted to the RFID tag to the prescribed value. Then, the processor shifts to the processing operation in ACT 34. Accordingly, the RFID paper Prf is printed with the incompatibility mark, conveyed on the second conveyance path, and output to the upper output tray 29B and the incompatibility display is performed on the display device 4a of the operation panel 4.

As described above in detail, the image forming apparatus 100 according to the embodiment includes the transfer unit 27 that transfers the toner image of the image formed on the transfer belt 26 by the image forming unit 24 to the RFID paper Prf having the RFID tag, i.e., prints the image. The image forming apparatus 100 includes the RFID reader/writer 5 that communicates with the RFID tag of the RFID paper Prf conveyed by the conveyance device 22 at the position between the paper feed cassette or the manual feed tray 20D and the transfer unit 27. The RFID reader/writer 5 communicates with the RFID tag, thereby writing data to the RFID tag and reading data written to the RFID tag. In addition, the image forming apparatus 100 includes the conveyance device 22, the image forming unit 24, the transfer belt 26, and the transfer unit 27, and the processor 61 of the controller 6 that controls the RFID reader/writer 5. In this manner, the RFID tag is the target wireless tag, i.e., the tag A, which is a wireless tag that is a data writing target. The RFID paper Prf is a medium having the tag A. Moreover, the image forming unit 24, the transfer belt 26, and the transfer unit 27 are an image forming device that forms an arbitrary image on the medium having the tag A. The RFID reader/writer 5 is a wireless tag communication device that is arranged at a predetermined position with respect to the image forming device, communicates with the tag A, writes data to the tag A, and reads the data written to the tag A. Then, the processor 61 of the controller 6 is a device that controls the image forming device and the wireless tag communication device. Then, in accordance with the image forming apparatus 100 according to the embodiment, the processor 61 performs the recognition processing for recognizing the tag A by reading the data prestored in the EPC area of the tag A, for example, the initial data included in the identification data through the RFID reader/writer 5, preceding writing of arbitrary data to the tag A of the RFID paper Prf by the RFID reader/writer 5. In a case where the recognition processing of the tag A has failed, the processor 61 performs at least one of stepwisely decreasing the reception threshold of the radio signal strength (RSSI) to be returned from the tag A or stepwisely increasing the radio signal strength to be transmitted to the tag A and reads the data prestored in the EPC area through the RFID reader/writer 5, thereby performing re-recognition processing for recognizing the tag A of the RFID paper Prf. The processor 61 notifies the user that the RFID paper Prf whose tag A has been recognized in the re-recognition processing is a re-recognized medium whose RFID tag has been recognized in the re-recognition processing. The user who has received this notification can know the re-recognized medium whose tag A could have been recognized by the re-recognition processing even if the user has failed to recognize the tag A. That is, the user can know that the medium is the re-recognized medium to which the user fails to write data in the normal settings, but the user can write data by changing the settings. Therefore, the user can use the re-recognized medium without discarding the re-recognized medium. In this manner, in accordance with the embodiment, the image forming apparatus that enables the medium having the wireless tag to which the user fails to write data to be reused can be provided.

Moreover, the image forming apparatus 100 according to the embodiment further includes the conveyance device 22 that conveys, from the paper feed cassette (e.g., the paper feed cassette 20A) or the manual feed tray 20D on which one or more sheets of RFID paper Prf each having the tag A can be placed, the sheets of RFID paper Prf one by one. Unlike the RFID paper Prf whose tag A has been recognized in the normal settings, the processor 61 of the controller 6 causes the conveyance device to convey the re-recognized medium to a prescribed output position without forming an arbitrary image on the image forming device (the image forming unit 24, the transfer belt 26, and the transfer unit 27). Therefore, in accordance with the embodiment, the processor 61 is capable of easily notifying the user of the re-recognized medium by making the paper the blank paper and changing the output position. In addition, outputting the paper as blank paper without printing, i.e., not performing unnecessary printing can save the toner. Moreover, since it is the blank paper, the re-recognized medium can also be reused as regular paper (paper not having RFID).

Here, the image forming apparatus 100 according to the embodiment further includes at least the lower output tray 29A that is the first output part and the upper output tray 29B that is the second output part. The processor 61 of the controller 6 causes the conveyance device 22 to convey the RFID paper Prf on which an arbitrary image is formed and arbitrary data is written at the tag A to the lower output tray 29A. The processor 61 of the controller 6 causes the conveyance device 22 to convey the re-recognized medium to the upper output tray 29B that is the prescribed output position. Therefore, in accordance with the embodiment, the processor 61 is capable of easily notifying the user of the re-recognized medium by outputting the re-recognized medium to the upper output tray 29B.

In addition, the image forming apparatus 100 according to the embodiment further includes the position-fixed tag TG that is a position-fixed wireless tag attached to a predetermined position. The processor 61 of the controller 6 further recognizes the position-fixed tag TG by reading, for example, the initial data prestored in the position-fixed tag TG through the RFID reader/writer 5 at the time of re-recognition of the tag A. When the processor 61 recognizes this position-fixed tag TG, the processor 61 notifies the user that the RFID paper Prf having the tag A is an incompatible medium having an incompatible RFID tag that cannot be used with the image forming apparatus 100. The user who has received this notification can know the RFID paper Prf that can be used with another apparatus even if the user has failed to recognize the tag A. Therefore, in accordance with the embodiment, the image forming apparatus that enables the medium having the wireless tag to which the user fails to write data to be reused can be provided.

Moreover, in the image forming apparatus 100 according to the embodiment, the processor 61 of the controller 6 causes the image forming part to form the image indicating the incompatibility on the RFID paper Prf having the incompatible tag A, and then causes the conveyance device to convey the RFID paper Prf to the prescribed output position. Therefore, in accordance with the embodiment, the processor 61 is capable of easily notifying the user of the incompatible medium by forming the image indicating the incompatibility and changing the output position.

Moreover, the image forming apparatus 100 according to the embodiment further includes the resist rollers 23 that is arranged in front of the transfer unit 27 and temporarily stops the conveyed RFID paper Prf. The RFID reader/writer 5 is arranged at such a position that the RFID reader/writer 5 can communicate with the RFID tag of the RFID paper Prf temporarily stopped at the position where the RFID paper Prf is temporarily stopped by the resist rollers 23. Then, the processor 61 of the controller 6 controls the RFID reader/writer 5 to write and read data to/from the RFID tag while the RFID paper Prf is temporarily stopped by the resist rollers 23. Reliable data writing and reading can be realized because the data writing and reading to/from the RFID tag by the RFID reader/writer 5 is performed in a state in which the RFID paper Prf is stopped in this manner.

Although one embodiment has been described above, embodiments are not limited thereto.

For example, in the above-mentioned embodiment, the lower output tray 29A is set as the first output part to which the RFID paper Prf on which the data is written and the image is printed is output and the upper output tray 29B is set as the second output part to which the re-recognized medium or the incompatible medium is output, though they may be opposite. Moreover, in a case where the output destination of the RFID paper Prf is specified by the user, the second output part may be an output tray not specified as the output destination. In a case where there are three or more output trays, any one output tray other than an output tray set as the first output part may be the second output part. In addition, in a case where there are three or more output trays, it is also possible to separate the output tray to which the re-recognized medium is output from the output tray to which the incompatible medium is output.

Moreover, in the above-mentioned embodiment, the reception threshold of the radio signal strength (RSSI) to be returned from the tag A is first stepwisely decreased, and then the radio signal strength to be transmitted to the tag A is stepwisely increased. However, the order of processing may be opposite or the reception threshold and the radio signal strength to be transmitted may be changed simultaneously, rather than separately.

Moreover, in the above-mentioned embodiment, the data writing and reading to/from the tag A is repeatedly retried until the limit time elapses. However, the number of retries may be used instead of time to determine whether or not to repeat the processing.

Moreover, in the above-mentioned embodiment, the notification of the error or incompatibility to the user is performed by the display on the display device 4a of the operation panel 4. However, an error notice or incompatible notice may be transmitted by the communication interface 69 to the server apparatus or user terminal that is a sender of arbitrary image data indicating the image to be printed on the RFID paper Prf and arbitrary user data to be written to the RFID tag of the RFID paper Prf.

Moreover, the flow of each process described above with reference to the flowchart is not limited to the above-mentioned procedures. For example, the processing operation of the void output in ACT 22 and the processing operation of the error display in ACT 23 may be performed in reverse order or concurrently. In this manner, some processing operations may be performed concurrently, the order of some processing operations may be interchanged, and the processing contents of some processing operations may be modified.

Moreover, in the above-mentioned embodiment, the MFP has been described as an example of the image forming apparatus 100. However, the image forming apparatus may be a printer not having a scanner as a matter of course.

Moreover, in the above-mentioned embodiment, the programs are stored in advance in the ROM 62 or the auxiliary storage device 64 of the controller 6 of the image forming apparatus 100. In this regard, programs that are transferred separately from the image forming apparatus may be written to a writable storage device provided in the image forming apparatus 100 in response to operations made by the manager or the like. These programs and the like may be transferred by storing them on a removable computer-readable storage medium or by communication over a network. The computer-readable storage medium may be in any form, such as a CD-ROM or memory card, as long as it can store the programs and be readable by the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
an image forming device configured to form an arbitrary image on a medium having a target wireless tag, which is a wireless tag that is a data writing target;
a wireless tag communication device that is arranged at a predetermined position with respect to the image forming device and configured to communicate with the target wireless tag of the medium, and write data to the target wireless tag and read data written to the target wireless tag; and
a processor configured to
preceding writing of arbitrary data to the target wireless tag by the wireless tag communication device, read data prestored in the target wireless tag by the wireless tag communication device and perform recognition processing for recognizing the target wireless tag on a basis of the read data,
in a case where the recognition processing for the target wireless tag has failed, perform at least one of stepwisely decreasing a reception threshold of radio signal strength to be returned from the target wireless tag or stepwisely increasing radio signal strength to be transmitted to the target wireless tag, read data prestored by the wireless tag communication device, and perform re-recognition processing for recognizing the target wireless tag on a basis of the read data, and
notify a user that the medium having the target wireless tag recognized in the re-recognition processing is a re-recognized medium whose target wireless tag has been recognized in the re-recognition processing.

2. The image forming apparatus according to claim 1, further comprising
a conveyance device that conveys the medium to a prescribed output position via a transfer position where an image is formed by the image forming device.

3. The image forming apparatus according to claim 2, wherein
the image forming device includes
an image forming unit that forms an image on an intermediate transfer medium and
a transfer unit that transfers, at the transfer position, the image to the medium conveyed by the conveyance device from the intermediate transfer medium.

4. The image forming apparatus according to claim 2, wherein
in a case where the medium is the re-recognized medium, the processor causes the conveyance device to convey the re-recognized medium to a prescribed output position in a manner to prevent the image forming the arbitrary image on the re-recognized medium.

5. The image forming apparatus according to claim 2, further comprising
at least first and second output parts to which the medium is output, and
the processor causes
the conveyance device to convey the medium on which the arbitrary image is formed and the arbitrary data is written at the target wireless tag to the first output part, and
causes the conveyance device to convey the re-recognized medium to the second output part that is the prescribed output position.

6. The image forming apparatus according to claim 2, further comprising
a display device, wherein
the processor causes the display device to perform display to indicate that the re-recognized medium is conveyed to the prescribed output position.

7. The image forming apparatus according to claim 1, further comprising
a position-fixed wireless tag that is attached to a predetermined position, wherein
the processor
further reads data prestored in the position-fixed wireless tag by the wireless tag communication device and performs recognition processing of recognizing the position-fixed wireless tag on a basis of the read data when the processor performs the re-recognition processing for the target wireless tag, and
notifies the user that the medium having the target wireless tag is a medium having a wireless tag unusable with the image forming apparatus if the processor has recognized the position-fixed wireless tag.

8. The image forming apparatus according to claim 3, wherein
the processor reads data prestored in the target wireless tag by the wireless tag communication device and performs the recognition processing for recognizing the target wireless tag on a basis of the read data at a time when the medium reaches a write position more forward than the transfer position in a conveyance direction in which the medium is conveyed by the conveyance device.

9. The image forming apparatus according to claim 8, wherein
the processor performs at least one of stepwisely decreasing a reception threshold of radio signal strength to be returned from the target wireless tag or stepwisely increasing radio signal strength to be transmitted to the target wireless tag, reads data prestored by the wireless tag communication device, and performs re-recognition processing for recognizing the target wireless tag on a basis of the read data at a time when the medium reaches the write position in a case where the recognition processing for the target wireless tag has failed.

10. The image forming apparatus according to claim 8, further comprising
a resist roller that conveys the medium to the transfer position in accordance with an image forming timing of the image forming device, wherein
the write position is a position where the resist roller is arranged.
